(19) United States
(12) Patent Application Publication
(10) Pub. No.: US 2014/0113063 A1
(43) Pub. Date: Apr. 24, 2014

(54) METHOD OF MANUFACTURING BATTERY ELECTRODE AND APPARATUS

(71) Applicant: Takahiko NAKANO, Seto-shi (JP)

(72) Inventor: Takahiko NAKANO, Seto-shi (JP)

(73) Assignee: TOYOTA JIDOSHA KABUSHIKI KAISHA, Toyota-shi (JP)

(21) Appl. No.: 14/047,216

(22) Filed: Oct. 7, 2013

(30) Foreign Application Priority Data
Oct. 19, 2012 (JP) 2012-231677

(51) Int. Cl. H01M 4/04

(52) U.S. Cl. CPC H01M 4/0471
USPC 427/8; 118/712

(57) ABSTRACT

A method of manufacturing a battery electrode includes the steps of: coating an electrode paste on an electrode base material; drying the electrode paste coated on the electrode base material in a drying furnace; measuring a radiation heat of the electrode paste during drying with a radiation heat meter; and determining a dried state of the electrode paste during drying based on the measured radiation heat.

### INCORPORATION BY REFERENCE

The disclosure of Japanese Patent Application No. 2012-231677 filed on Oct. 19, 2012 including the specification, drawings and abstract is incorporated herein by reference in its entirety.

### BACKGROUND OF THE INVENTION

1. Field of the Invention

The present invention relates to a method of manufacturing a battery electrode and an apparatus for manufacturing the battery electrode.

2. Description of Related Art

In Japanese Patent Application Publication No. 2003-178752 (JP 2003-178752 A), there is disclosed a method of evaluating a dried state of an electrode paste coated on a electrode base sheet in a manufacturing process of a sheet electrode used in a nonaqueous electrolyte secondary battery. According to the method of evaluating a dried state, which is disclosed in JP 2003-178752 A, a temperature measurement means is buried in the electrode paste, and from a inflection point of a temperature change with respect to a traveling time or a traveling distance of the temperature measurement means in a drying apparatus, a the dried state of the electrode paste is evaluated.

According to the method of evaluating a dried state, which is disclosed in JP 2003-178752 A, an evaluation for verifying a drying condition of an the electrode paste can be performed as an advance preparation, but the dried state of the electrode paste in an actual manufacturing process cannot be determined. Therefore, when the drying condition changes in a post-hoc manner due to an influence of an environmental change, for example, the electrode paste may not be fully dried. That is, there is a problem that according to the method of evaluating a dried state, which is disclosed in JP 2003-178752 A, a yield of battery electrodes cannot be improved.

### SUMMARY OF THE INVENTION

The present invention provides a method of manufacturing a battery electrode, which can improve a yield by determining a dried state of an electrode paste during a manufacturing process, and an apparatus for manufacturing the battery electrode.

A first aspect of the present invention relates to a method of manufacturing a battery electrode, which includes: coating an electrode paste on an electrode base material; drying the electrode paste coated on the electrode base material in a drying furnace; measuring a radiation heat of the electrode paste during drying with a radiation heat meter; and determining a dried state of the electrode paste based on the measured radiation heat. According to the method, since the dried state of the electrode paste in the manufacturing process can be determined, a yield can be improved.

The radiation heat meter may be disposed in a place where an atmospheric temperature in the drying furnace is constant. Thereby, the dried state can be determined without being affected by an evaporated solvent.

Air may be blown between the electrode paste during drying and the radiation heat meter. Thereby, even in the course of drying, the dried state can be determined without being affected by the evaporated solvent.

The radiation heat meter may include an infrared absorption sensor.

A second aspect of the present invention relates to an apparatus for manufacturing a battery electrode, which includes: a drying apparatus that dries an electrode paste coated on an electrode base material in a drying furnace; a radiation heat meter that measures a radiation heat of the electrode paste during drying; and a determining section that determines a dried state of the electrode paste based on the measured radiation heat. Thereby, since the dried state of the electrode paste can be determined in the manufacturing process, a yield can be improved.

According to the present invention, the method of manufacturing a battery electrode, which can improve the yield by determining the dried state of the electrode paste during the manufacturing process, and the apparatus can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional schematic diagram showing a principle of a lithium ion secondary battery;

FIG. 2 is a diagram showing an apparatus for manufacturing a battery electrode according to an embodiment of the present invention; and

FIG. 3 is a diagram showing a relationship between a drying time of an electrode paste, a temperature of the electrode paste and an amount of evaporated solvent in a drying furnace.

### DETAILED DESCRIPTION OF EMBODIMENTS

Hereinafter, an embodiment of the present invention will be described with reference to drawings. First of all, a lithium ion secondary battery that is one of batteries manufactured by an electrode manufacturing apparatus (apparatus for manufacturing a battery electrode) of the present embodiment will be described.

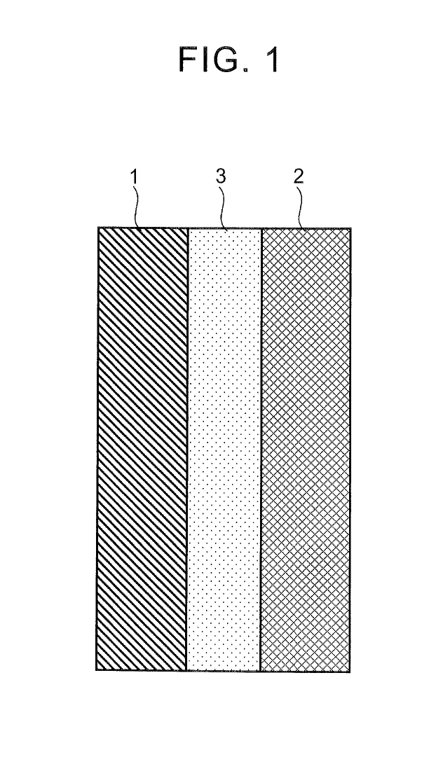

FIG. 1 is a sectional schematic view showing a principle of a lithium ion secondary battery. A lithium ion secondary battery can supply electric power to a predetermined load (not shown in the drawing). As shown in FIG. 1, the lithium ion secondary battery includes a positive electrode 1 that supports a positive electrode active material, a negative electrode 2 that supports a negative electrode active material, and a separator 3 disposed between the positive electrode 1 and the negative electrode 2. The positive electrode 1 and negative electrode 2 are porous and contain a non-aqueous electrolyte solution.

An actual lithium ion secondary battery has, for example, a wound structure where the belt-like positive electrode 1 and the belt-like negative electrode 2 are wound via the belt-like separator 3 or a laminate structure where the plurality of positive electrodes 1 and the plurality of negative electrodes 2 are alternately laminated via the separator 3. Further, the lithium ion secondary battery may be a single lithium ion secondary battery or a battery pack configured by electrically connecting the plurality of lithium ion secondary batteries.

### (Positive Electrode 1)

The positive electrode 1 includes a positive electrode active material. The positive electrode active material is a material that can store and release lithium. As the positive electrode active material, for example, lithium cobalt oxide (LiCoO₂), lithium manganese oxide (LiMn₂O₄), and lithium nickel oxide (LiNiO₂) can be used. A material obtained by mixing LiCoO₂, LiMn₂O₄, and LiNiO₂ at an optional ratio and by firing the mixture may be used. As an example of composition, for example, LiNi_{1/3}Co_{1/3}Mn_{1/3}O₂ obtained by mixing these materials at an equal ratio can be cited.

Further, the positive electrode 1 may contain a conductive agent. As the conductive agent, for example, carbon black such as acetylene black (AB) and Ketjen black, and graphite can be used.

For example, the positive electrode 1 can be obtained by coating a positive electrode mixture (electrode paste) obtained by kneading a positive electrode active material, a conductive agent, a solvent, and a binder on a positive electrode current collector (electrode base material) and drying the coated positive electrode mixture. Here, as the solvent, for example, an N-methyl-2-pyrrolidone (NMP) solution can be used. As the binder, for example, polyvinylidene fluoride (PVDF), styrene butadiene rubber (SBR), polytetrafluoroethylene (PTFE), and carboxymethyl cellulose (CMC) can be used. Further, as the positive electrode current collector, a metal foil made of aluminum or aluminum alloy can be used.

### (Negative Electrode 2)

The negative electrode 2 includes a negative electrode active material. The negative electrode active material is a material that can store and release lithium, and, for example, a powdery carbon material made of graphite can be used. And, in the same manner as that of the positive electrode, the negative electrode active material, the solvent, and the binder are kneaded, the kneaded negative electrode mixture (electrode paste) is coated on a negative electrode current collector (electrode base material) and dried, thereby a negative electrode can be manufactured. As the negative electrode current collector, a metal foil made of, for example, copper, nickel or an alloy thereof can be used.

### (Separator 3)

As the separator 3, an insulating porous film can be used. For example, as the separator 3, porous polymer films such as a polyethylene film, a polyolefin film, and a polyvinyl chloride film, or an ion conductive polymer electrolyte film can be used.

These films, as the separator 3, may be used singularly or in a combination thereof.

### (Nonaqueous Electrolyte Solution)

A nonaqueous electrolyte solution is a composition where a support salt is contained in a nonaqueous solvent. Here, as the nonaqueous solvent, materials of one or more selected from the group of propylene carbonate (PC), ethylene carbonate (EC), diethyl carbonate (DEC), dimethyl carbonate (DMC), and ethyl methyl carbonate (EMC) can be used. Further, as the support salt, one or more of lithium compounds (lithium salts) selected from LiPF₆, LiBF₄, LiClO₄, LiAsF₆, LiCF₃SO₃, LiC₄F₉SO₃, LiN(CF₃SO₂)₂, LiC(CF₃SO₂)₃, and LiI can be used. <Description of Electrode Manufacturing Apparatus Relating to Present Embodiment>

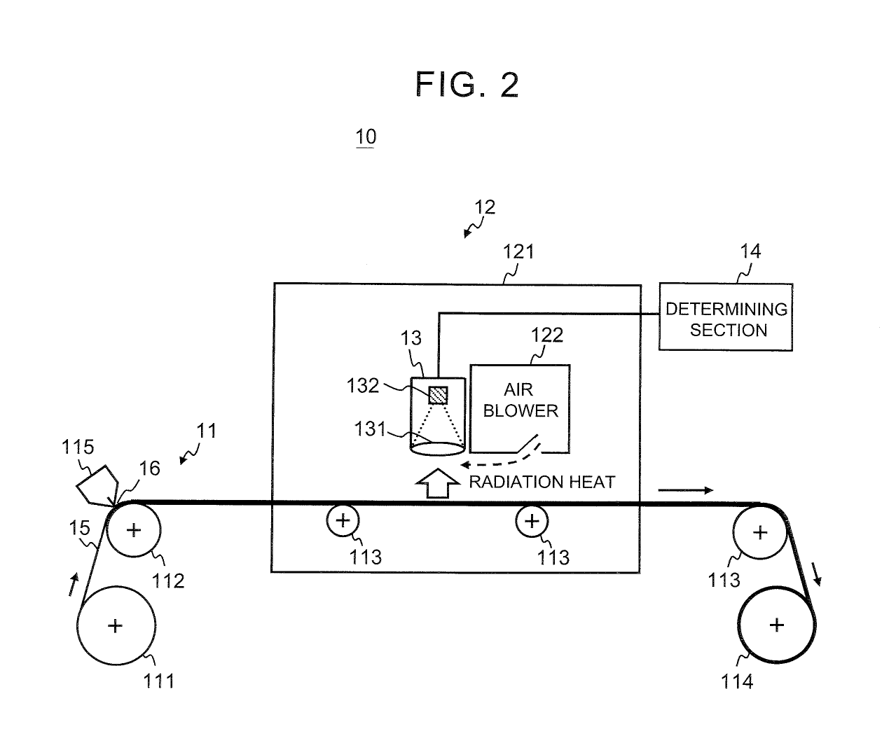

Next, with reference to FIG. 2, an electrode manufacturing apparatus according to the present embodiment will be described. FIG. 2 is a diagram showing an electrode manufacturing apparatus 10 according to the present embodiment. The electrode manufacturing apparatus 10 shown in FIG. 2 includes a conveying and coating apparatus 11, a drying apparatus 12, a sensor (radiation heat meter) 13, and a dried state determining section 14.

In the present embodiment, a case where the electrode manufacturing apparatus 10 manufactures a positive electrode of a lithium ion secondary battery will be described as an example. However, there is no limitation thereon. The electrode manufacturing apparatus 10 can also manufacture a negative electrode of a lithium ion secondary battery. Further, the electrode manufacturing apparatus 10 can also manufacture an electrode of other battery (secondary battery other than lithium ion secondary battery and fuel cell) where a sheet electrode is used.

### (Conveying and Coating Apparatus 11)

The conveying and coating apparatus 11 is an apparatus that, while coating the electrode paste on the electrode base material to form a sheet electrode, conveys the formed sheet electrode. Specifically, the conveying and coating apparatus 11 includes a unwinding roller 111, a backup roller 112, a guide roller 113, a rewinding roller 114, and a die 115.

An electrode base material 15 is continuously unwound from the unwinding roller 111, passes the backup roller 112 and the guide roller 113, and is rewound by the rewinding roller 114. The die 115 is disposed in the vicinity of the backup roller 112 and discharges an electrode paste 16.

The electrode base material 15 that is continuously unwound from the unwinding roller 111 is conveyed along a peripheral surface of the backup roller 112 and rewound by the rewinding roller 114. At this time, the electrode paste 16 discharged from the die 115 is coated by a predetermined amount on a surface of the electrode base material 15.

### (Drying Apparatus 12)

The drying apparatus 12 is an apparatus that dries the electrode paste 16 coated on the electrode base material 15. Specifically, the drying apparatus 12 includes a drying furnace 121 and an air blower 122.

The drying furnace 121 is a tunnel drying furnace, for example, and disposed in a post-stage of the backup roller 112. The air blower 122 is disposed inside the drying furnace 121 and blows hot air from one or more nozzles. The drying apparatus 12 dries the electrode paste 16 that is coated on the electrode base material 15 and conveyed inside the drying furnace 121 with hot air blown out from the air blower 122.

### (Sensor 13)

The sensor 13 is a section that measures a radiation heat of the electrode paste 16 during drying inside the drying furnace 121. The sensor 13 is an infrared absorption sensor, for example, and includes a lens 131 that collects the radiation heat (infrared ray energy) of the electrode paste 16 during drying and an absorber 132 that outputs temperature information of the electrode paste 16 from an amount (heat flux) of the radiation heat collected by the lens 131.

Here, a heat flux q [W/m²] is represented by the following formula (1).

q=σ·ε·T⁴ (1)

In the above, a represents Boltzmann constant (5.67×10⁻⁸ [W/m²k⁴]), ε represents emissivity, and T represents a temperature [K] of an object measured.

As obvious from the formula (1), by measuring radiation heat of the electrode paste 16 that is a measurement target to specify a heat flux (q) thereof, a temperature (T) of the electrode paste 16 that is a measurement target can be calculated.

The sensor 13 of the present embodiment is disposed in a place where an atmospheric temperature in the drying furnace 121 is constant. Thereby, the sensor 13 can measure the radiation heat of the electrode paste 16 with high accuracy without being affected by the evaporated solvent. (That is, the dried state determining section 14 described below can determine the dried state without being affected by the evaporated solvent).

Further, the sensor 13 of the present embodiment is disposed in the vicinity of a hot air outlet of the air blower 122. More specifically, the hot air is preferably blown out of the air blower 122 to a space between the sensor 13 and the electrode paste 16 during drying. Since the evaporated solvent present between the sensor 13 and the electrode paste 16 during drying is removed, the sensor 13 can measure even during drying the radiation heat of the electrode paste 16 with high accuracy without being affected by the evaporated solvent. (That is, the dried state determining section 14 described below can determine even during drying the dried state without being affected by the evaporated solvent).

When the electrode manufacturing apparatus 10 manufactures a positive electrode of a lithium ion secondary battery as a battery electrode, the sensor 13 is preferably structured to absorb infrared ray in the range of 4 to 5 μm and 10 to 14 μm. Thereby, the sensor 13 can measure the radiation heat of a measurement target with high accuracy.

On the other hand, when the electrode manufacturing apparatus 10 manufactures a negative electrode of a lithium ion secondary battery as a battery electrode, the sensor 13 is preferably structured to absorb infrared ray in the range of 7 to 14 μm. Thereby, the sensor 13 can measure the radiation heat of a measurement target with high accuracy.

Furthermore, when the electrode manufacturing apparatus 10 manufactures a positive electrode of a lithium ion secondary battery as a battery electrode, emissivity of a measurement target defined by the sensor 13 is preferably in the range of 0.9 to 0.95. Thereby, the sensor 13 can measure the radiation heat of a measurement target with high accuracy.

On the other hand, when the electrode manufacturing apparatus 10 manufactures a negative electrode of a lithium ion secondary battery as a battery electrode, emissivity of a measurement target defined by the sensor 13 is preferably in the range of 0.7 to 0.9. Thereby, the sensor 13 can measure the radiation heat of a measurement target with high accuracy.

### (Dried State Determining Section 14)

The dried state determining section 14 determines a dried state of the electrode paste 16 during drying based on measurements (temperature information) of the sensor 13. When the dried state determining section 14 determines, based on the measurements, that a temperature of the electrode paste 16 during drying reached a predetermined temperature, the dried state determining section 14 determines that the electrode paste 16 is sufficiently dried.

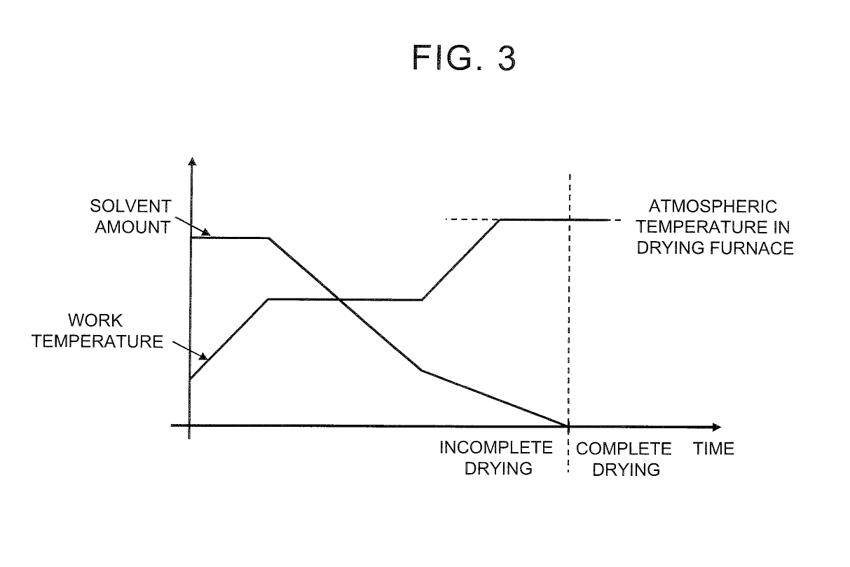

FIG. 3 is a diagram showing a relationship between a drying time of the electrode paste 16, and the temperature (work temperature) of the electrode paste 16 and an amount of evaporated solvent in the drying furnace 121.

As shown in FIG. 3, during an early stage of drying, since the electrode paste 16 is not dried, the temperature of the electrode paste 16 is low, and an amount of evaporated solvent in a furnace is large (concentration of the evaporated solvent is high). However, as the drying proceeds, the temperature of the electrode paste 16 increases and the amount of the evaporated solvent in the furnace decreases (the concentration of the evaporated solvent decreases). When the electrode paste 16 is dried enough, the temperature of the electrode paste 16 reaches the atmospheric temperature in the furnace and becomes constant. (Further, the evaporated solvent in the furnace at this time becomes nearly zero.)

Here, the dried state determining section 14 determines whether a temperature of the electrode paste 16 specified by the heat radiation of the electrode paste 16 during drying has reached the atmospheric temperature in the furnace to determine whether the electrode paste 16 is dried.

For example, when the temperature specified by the heat radiation of the electrode paste 16 during drying (that is, the temperature of the electrode paste 16 during drying) has not reached the atmospheric temperature in the furnace, the dried state determining section 14 determines that the electrode paste 16 is not sufficiently dried. On the other hand, when the temperature specified by the heat radiation of the electrode paste 16 during drying (that is, the temperature of the electrode paste 16 during drying) has reached the atmospheric temperature in the furnace, the dried state determining section 14 determines that the electrode paste 16 is sufficiently dried.

As described above, the electrode manufacturing apparatus according to the present embodiment includes a sensor that measures radiation heat of an electrode paste during drying, and a dried state determining section that determines the dried state of the electrode paste during drying based on measurement results of the sensor. Thereby, the electrode manufacturing apparatus 10 according to the embodiment can determine the dried state of the electrode paste in the manufacturing step (in-line determination). Thus, even when a drying condition is changed due to an atmospheric change, the dried state of the electrode paste can be determined with high accuracy. As a result thereof, the electrode manufacturing apparatus 10 according to the embodiment can improve a yield of battery electrodes.

In the above, the present invention has been described with reference to the embodiment. However, the present invention is not limited to a configuration of the embodiment and includes all of various modifications, corrections, and combinations, which a person skilled in the art can consider, in the range of the present invention.

What is claimed is:

1. A method of manufacturing a battery electrode, comprising:
coating an electrode paste on an electrode base material;
drying the electrode paste coated on the electrode base material in a drying furnace;
measuring a radiation heat of the electrode paste during drying with a radiation heat meter; and
determining a dried state of the electrode paste based on the measured radiation heat.

2. The method of manufacturing according to claim 1, wherein the radiation heat meter is disposed in a place where an atmospheric temperature in the drying furnace is constant.

3. The method of manufacturing according to claim 1, further comprising:
blowing air between the electrode paste during drying and the radiation heat meter.

4. The method of manufacturing according to claim 1, wherein the radiation heat meter includes an infrared absorption sensor.

5. An apparatus of manufacturing a battery electrode comprising:
a drying apparatus that dries an electrode paste coated on an electrode base material in a drying furnace;
a radiation heat meter that measures a radiation heat of the electrode paste during drying; and
a determining section that determines a dried state of the electrode paste based on the measured radiation heat.
